(19) United States
(12) Patent Application Publication
(10) Pub. No.: US 2004/0050278 A1
(43) Pub. Date: Mar. 18, 2004

(54) Method and apparatus for washing a roll

(76) Inventor: Kalervo Pulliainen, Jyvaskyla (FI)

Correspondence Address: Christopher J. Fildes, Fildes & Outland, 20916 Mack Avenue, Suite 2, Grosse Pointe Woods, MI, 48236, US

(21) Appl. No.: 10/433,587

(22) PCT Filed: Dec. 27, 2001
(86) PCT No.: PCT/FI01/01150

(30) Foreign Application Priority Data
Dec. 22, 2000 (FI) 20002826

(51) Int. Cl. B41F 35/00

(52) U.S. Cl. 101/425

(57) ABSTRACT

The invention relates to a method and apparatus for washing a roll particularly in a paper-coating station, in which the roll (11) is washed with a wash sponge (12) by moving it transversely across the roll (11) as the roll (11) rotates. The movement of the wash sponge (12) takes place mechanically. The washing apparatus includes a carrier beam (15) the width of and fitted close to the roll (11) being washed, a moving cradle (21) set on this to carry the washing device (16) and to transport it once or several times from one end of the roll (11) to the other.

The present invention relates to a method and apparatus in a paper-coating station, in which a roll is washed with a wash sponge, by moving it transversely across the station against the rotating roll.

In a paper-coating station, problems arise from the dirtying of the counter-roll pressing the paper web against the roll spreading the coating. Dirtying takes place especially in web-break situations, when, if web breaks at the coating station or before it, the counter-roll comes in contact with the spreader roll, which is in contact with the coating. The surface of the counter-roll then comes in contact with the coating, which must be washed off its surface before an attempt is made to rethread the tail. Reel changes at an individual coating machine, which is separate from the paper machine, take place ‘in flight’, when just before the bottom of the reel that is ending, the start of a new reel is glued onto the web for a distance of some tens of centimetres, after which the web coming from the reel that is ending is cut off. The jargon term for such a joint in a paper web is a ‘flying splice’. A joint of this kind can cause coating splashes at the coating station. If the joint is not made properly, there may be holes in it, so that coating will also come through them onto the counter-roll. In addition, dirtying of the counter-roll and unevenness in the coating layer is also caused by dust coming off the paper web during production and holes at other places in the web than at the reel joints. In the worst case, coating coming from the spreader roll onto the counter-roll will cause the web to wrap around the counter-roll and lead to a break.

At present, the counter-roll is washed manually. When washing is required, the machine operator climbs on the coating station's maintenance platform with a wash sponge attached to a pole, which he moves against the rotating counter-roll for as long as he considers necessary. From the work safety point of view, the task is dangerous, as the rotating counter-roll is close to the operator and the sponge on the pole may catch on the counter-roll and pull the operator with it.

Time is also lost and broke created by the machine operator having to move from the coating station's control point and climb onto the maintenance platform to wash the roll and then return to the control point. These moves also delay the restarting of the coater.

Previously, water-jet washers have also been used to wash counter-rolls at coating stations. These cause splashing and, as they extend over the full width of the station, use much is water, which must be drained away. In addition, the result of washing with only a jet of water is often insufficient.

The counter-roll of a coating station is subject to strict cleanliness requirements, as it is used to press the paper web being coated against the spreader roll, so that any unevenness on the counter-roll will lead to an unsatisfactory coating result. A sticky counter-roll will also make the web adhere to the counter-roll, and scraping it off will delay the start-up of production.

The invention is intended to create a method and apparatus, by means of which the counter-roll of a paper coating station can be washed. The characteristic features of the method according to the invention are stated in the accompanying claim 1 and the characteristic features of the apparatus in claim 3.

Compared to the previous method, the washing of the counter-roll of a paper coating station is safer for the machine operating personnel. The machine operator need no longer climb into the middle of a running machine to wash the rotating counter-roll with a sponge on a pole, but can supervise and, if necessary, control the wash event from a control desk to suit the requirements the moment. As washing, according to the invention, is mechanically programmed, the wash event is optimized efficiently and fully automatically. The wash result is much better than before and, if a break occurs, production can be restarted more rapidly than before, because the machine operator no longer has to actually carry out the washing on the maintenance platform, but can use a control desk.

In the following, the invention is examined with reference to the accompanying drawings, which show a coating station and a washing apparatus, according to the invention, located in it.

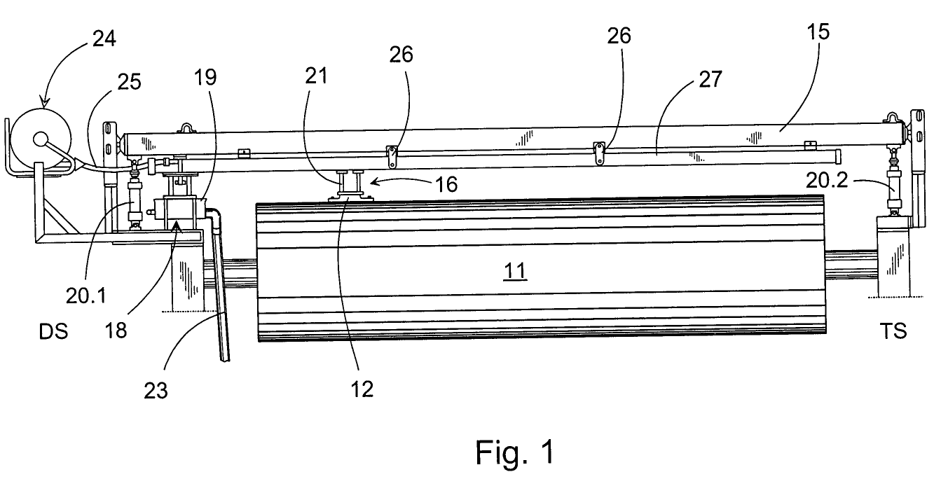

FIG. 1 shows the washing apparatus according to the invention located in a paper-coating station, seen from in front of the coater.

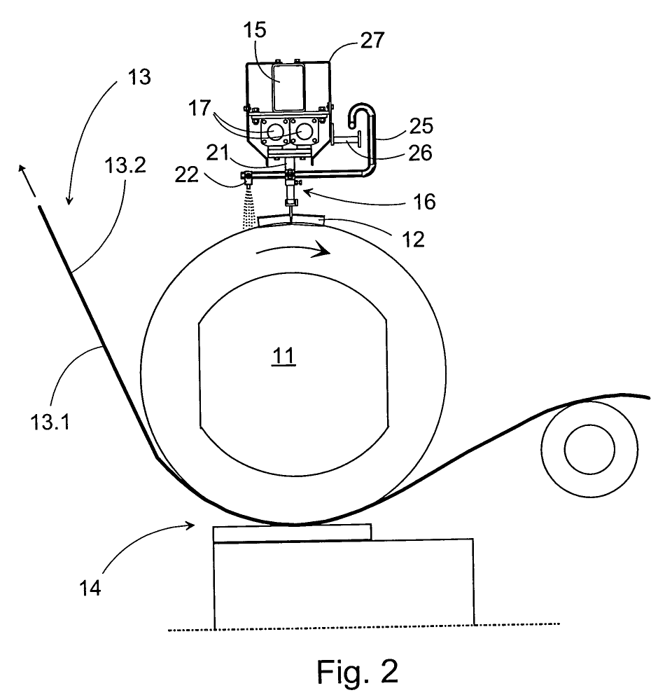

FIG. 2 shows a cross-section of the washing apparatus according to the invention located in a paper-coating station, seen from the drive side.

In FIG. 1, the coating station is seen from in front of the coater. The coating station may be a coater that is separate from the actual paper machine, or part of an unbroken production line permanently connected to the paper machine. A separate coater includes not only the coating station, but also components such as a paper reel unwinder and various types of dryers (not shown). The coating station comprises the coater's coating spreader roll (not shown) and its counter-roll 11. The coating can be placed on the spreader roll in several different ways. The paper web 13 travels through the coating nip 14 formed by these rolls in such a way that the spreader roll spreads the coating evenly on one side 13.1 of the paper web 13 while the counter-roll 11 presses the paper web 13 against the spreader roll from the opposite side 13.2.

The washing apparatus according to the invention is attached above the counter-roll 11. A carrier beam 15, supported at its ends by vertical guides 20.1, 20.2, on which the washing apparatus 16 is mounted, is installed above the counter-roll 11. The vertical guides 20.1, 20.2 permit the washing device 16 to be placed in operating and rest positions. The washing apparatus 16 comprises two pneumatically-operated cylinders 17 without piston rods, which are moved parallel to the counter-roll 11. The cylinders 17 are attached to the carrier beam 15. A replaceable wash sponge 12, which can be preferably conventional, is installed in the cradle 21 of the cylinders 17. The home station 18 of the washing device 16, in which the washing device 16 is kept when not in use, and which is installed in the area between the carrier beam 15 with its vertical guides 20.1 and the counter-roll 11, is on the drive side DS of the coating station. The home station 18 includes a rinse tank 19 for the wash sponge 12, into which a cold-water spray, brought from the drive side DS of the coating station, is directed, and which is drained through a drainpipe 23 leading from the bottom of the tank. The compressed air used to move the washing device 16 is taken, like the spraying and rinsing water, from the mill networks. The spraying water is led with a hose 25 running off from a spring-loaded reel 24, which adapts to movement parallel to the counter-roll 11 of the washing device 16, the hose being located in the immediate vicinity of the home station 18 of the washing device 16. The hose runs off the reel 24 according to the movement of the washing device 16 and reels back when a spring (not shown), tensioned when it runs off, is released.

In this example, the wash sponge is sized 200×300 mm and is of the ‘bear's tongue’ type, i.e. it is quite rough. As such, it is possible to use the same material that is used in manual washing.

FIG. 2 shows a cross-section of the coating station according to the invention, seen from the drive side DS. A spray-water feed 22, equipped with a slit nozzle, is placed in front of the wash sponge 12 in the direction of rotation of the counter-roll 11. The spray water can be directed either at the counter-roll 11, as shown in FIG. 2, or to an area corresponding to the width of the wash sponge 12, at the point of contact between the wash sponge 12 and the counter-roll 11. The reeled out hose 25 is prevented from dropping onto the counter-roll 11 by a hose carrier 26, which is attached to the protective cover 27 of the carrier beam 15 and the cylinders 17.

The invention operates as follows. The washing device 16 is given a stand-by command from the logic of the coater when a ‘flying splice’ is approaching. The wash sponge 12 is then rinsed in the rinse tank 19 of the home station 18, lifted out is of the rinse tank 19 and run to the starting position at the drive-side DS end of the counter-roll 11. The machine's control logic notifies when the joint has passed the counter-roll 11 and the wash sponge 12 is lowered by the carrier beam 15 onto the surface of the counter-roll 11. The cylinders 17 drive the sponge 12 to the tending side TS of the counter-roll 11 and bring it back to the drive side DS end. This movement is repeated a set number of times. After this, the wash sponge 12 is lifted clear of the counter-roll 11, moved by the cylinders to above the home station 18 and lowered into the rinse tank 19 for rinsing. The lifting and lowering of the wash sponge 12 take place with the aid of the vertical guides 20.1 and 20.2 of the carrier beam 15.

During the washing of the counter-roll 11, the wetting water nozzle 22 continuously feeds more water, either to the counter-roll 11, or to the point of contact between the wash sponge 12 and the counter-roll 11. The speed of the wash sponge 12 transversely over the surface of the counter-roll 11 is synchronized with the speed of the coater by the control of the washing device 16, so that the wash sponge 12 washes the entire area of the cover of the counter-roll 11 during a single transverse movement. The operation of the washing device 16 can also be concentrated, for example, on a dirty area on the counter-roll 11, in which case the wash sponge 12 can be run under manual control backwards and forwards over the area. If necessary, the speed of the wash sponge 12 can be adjusted by regulating the pressure from the control desk, but normally a speed synchronized with the machine speed will be sufficient. If a web break occurs during washing, the wash program stops and the wash sponge 12 rises off the counter-roll 11. After the web break, the wash sponge 12 must be run manually to the rinse tank 19 at the home position 18.

The washing device 16 can be used, not only in ‘flying splice’ situations, but also if the counter-roll 11 has come into is contact with the coating during a web break. When coating, the counter-roll 11 can be washed with the wash sponge, to remove dust adhering to it from the paper web 13 and coating that has transferred from the spreader roll to the counter-roll 11 through possible holes.

The use of the washing apparatus according to the invention improves work safety and production efficiency. The washing apparatus can be easily installed in a coating station while its operation is simple and fully automatic, and its mechanical components are entirely maintenance free. The wash sponge 12 is preferably a conventional sponge, which can be easily replaced with a new one at the home position, when necessary. All the apparatus's steel components are preferably of acid-resistant steel. Wash water is only used at the point to be washed and is sprayed with a slit nozzle 22, thus saving water and reducing the waste water load. The wash and rinse water, as well as the compressed air needed to operate the apparatus, are preferably taken from the mill's existing networks. The control logic of the apparatus is preferably connected to the coater's control logic. The invention can also be applied at other points in a paper or board machine, which require roll washing.

In one application it was noticed that the pneumatic cylinders created an uneven movement. In this case, the cylinders were replaced with a toothed belt. The endless toothed belt is driven at one end by a stepping motor, the toothed belt running over a sprocket at the opposite end. The cradle is attached to the toothed belt.

1. A method in washing a roll in a paper-coating station, in which the roll (11) is washed by a wash sponge (12) by moving it transversely against the roll (11) while the roll (11) rotates, characterized in that the movement of the wash sponge (11) takes place mechanically.

2. A method according to claim 1, characterized in that the wash sponge (12) or the area of the roll (11) in front of the wash sponge (12) in the direction of rotation is wetted with a wash fluid.

3. A washing apparatus for roll washing in a paper-coating station, which includes a rotating spreader roll and its counter-roll (11) set against each other, the spreader roll being used to spread coating on the paper web (13) travelling from the nip (14) formed by the rolls, while the counter-roll (11) is used to press the paper web (13) against the spreader roll, characterized in that the washing apparatus includes a carrier beam (15) the width of, and fitted in the immediate vicinity of the roll (11) to be washed, a moving cradle (21) placed on the beam, to support the washing device (16) and to transport it once or several times from one end of the roll (11) to the other.

4. A washing apparatus according to claim 3, characterized in that: the washing means of the washing device (16) is a wash sponge (12).

5. A washing apparatus according to claim 3 or 4, characterized in that water feed devices (22, 24, 25) are fitted to the washing apparatus, to wet the wash sponge (12) and the counter-roll (11).

6. A washing apparatus according to claim 5, characterized in that the water feed devices of the washing apparatus include a hose reel (24), a hose (25), and a spray-water nozzle (22).

7. A: washing apparatus according to any of claims 3-6, characterized in that the carrier beam (15) of the washing device (16) is arranged to be installed on vertical guides (20.1, 20.2) in particular operating and rest positions.

8. A washing apparatus according to any of claims 3-7, characterized in that the washing device's (16) drained home station, (18) is arranged at at least one end of the coating station and includes a rinse tank (19) and a water jet directed into it to rinse the wash sponge (12).

9. A washing apparatus according to any of claims 3-8, characterized in that the control logic of the washing device (16) is adapted to the control logic of the coater.

10. A washing apparatus according to any of claims 3-9, characterized in that the speed of the washing device (16) is adapted to the speed of the coater.

11. W washing apparatus according to any of claims 3-10, characterized in that the drive device of the cradle comprises a toothed-belt drive.
